(19) United States
(12) Patent Application Publication
(10) Pub. No.: US 2026/0024406 A1
(43) Pub. Date: Jan. 22, 2026

(54) BETTING AMOUNT PROPORTION DISPLAY SYSTEM FOR ROULETTE

(71) Applicant: JUMBO TECHNOLOGY CO., LTD., TAICHUNG (TW)

(72) Inventors: Shun Tsung HSU, TAICHUNG (TW); Chang Yi WANG, TAICHUNG (TW)

(21) Appl. No.: 18/777,054

(22) Filed: Jul. 18, 2024

(51) Int. Cl. G07F 17/32

(52) U.S. Cl. CPC G07F 17/323; G07F 17/3211; G07F 17/3288

(57) ABSTRACT

A betting amount proportion display system for roulette calculates and obtains a substantial betting point of game results respectively through a game processing unit, and performs a numerical range classification on numerical values of the points of the game results, so that the points are arranged from small to large numerical values and classified to belong to range groups Pi, i=one of 1, 2, . . . , N, N is greater than or equal to 3. The roulette image displays the game results arranged in a ring, and the roulette image displays bars at positions adjacent to the game results, the bars correspondingly show the points of the adjacent game results, so that betting amounts of the points are displayed proportionally, a length of each bar correspondingly shows the range group Pi, i=1, 2, . . . , N the points are classified to belong to.

### FIELD OF THE INVENTION

The invention relates to a game system, more particularly to a betting amount proportion display system for roulette.

### BACKGROUND OF THE INVENTION

The roulette game has the characteristics of high odds, easy-to-learn rules, and difficulty in cheating, so it is widely popular among players. The roulette game mainly provides a roulette wheel and a colored ball for playing the game. The roulette area is usually divided into 37 areas, which are marked with numbers 0˜36 respectively. The colored ball is thrown into the rotating roulette wheel and rolls along with the roulette wheel. After the roulette wheel stops, the colored ball continues to roll due to inertia until the inertia is exhausted and stops in one of the 37 areas, thereby producing one of 37 game outcomes.

The roulette game provides a betting interface for players to bet. The betting interface has a plurality of betting areas corresponding to 37 game results. Each of the betting areas corresponds to at least one of the game results, and each of the betting areas has a different payout odds based on the probability of occurrence of the corresponding game result. When the game result corresponding to the betting area that the player bets on occurs in the roulette game, the payout will be based on the payout odds and the player's betting points. Common betting areas comprise single bets (0˜36), column bets (first column˜third column), dozen bets (first dozen˜third dozen), even/odd bet, red/black bet, high/low bet (“1 to 18”, “19 to 36”), etc., when the players bet on the betting areas, the game results corresponding to the betting areas will be repeated, so it is not easy for the players to grasp how many points are paid out when the roulette game produces a specific game result.

Therefore, the conventional technology will convert the player's bets on the betting areas into the substantial betting points of the game results respectively, and display them in a graphical representation on the virtual roulette wheel, so that the player can grasp the substantial betting points of the game results respectively.

However, when the virtual roulette wheel displays the substantial betting points of the game results respectively in a graphical representation, especially when the numerical values of the substantial betting points are expressed in the form of displayed length, it is often difficult to quickly judge due to inappropriate scale. For example, if the virtual roulette wheel uses a displayed length to represent the numerical values of the substantial betting points, if the respective substantial betting points of the game results are too small, the displayed length will also be too short and difficult to interpret. On the contrary, if the respective substantial betting points of the game results are too large, the length will exceed the boundary of the graphical representation, the respective substantial betting points of the game results can only show the same length, and therefore the numerical values of the substantial betting points cannot be judged.

### SUMMARY OF THE INVENTION

A main object of the invention is to provide a betting amount proportion display system for roulette, which capable of graphically displaying a player's substantial betting points for each game result in a roulette game with the most suitable scale.

In order to achieve the above object, the invention provides a betting amount proportion display system for roulette, comprising a game processing unit, a game result generating unit, a betting interface and a game status display screen. The game processing unit is configured to control an operation of a roulette game provided for a player to play the roulette game. The game result generating unit is connected to the game processing unit, and the game result generating unit comprises a plurality of game results, wherein after a betting time of each round of the roulette game ending, the game result generating unit designates one of the plurality of game results according to a preset rule and transmits the game result which is designated to the game processing unit. The betting interface is connected to the game processing unit, and the betting interface comprises a plurality of betting areas corresponding to the game results, each of the plurality of betting areas corresponds to at least one of the game results. The betting interface is provided for the player to bet on the plurality of betting areas within the betting time to generate a betting datum recording a betting amount of each of the plurality of betting areas, and the betting interface transmits the betting datum to the game processing unit, wherein after obtaining the betting datum, the game processing unit calculates and obtains substantial betting points of the plurality of game results based on the betting amount of the corresponding betting areas, and performs a numerical range classification on numerical values of the substantial betting points of the plurality of game results, so that the substantial betting points of the plurality of game results is arranged from small to large numerical values and classified to belong to a plurality of range groups Pi, wherein i is one of 1, 2, . . . , N, and N is greater than or equal to 3. The game status display screen is connected to the game processing unit, the game status display screen configured to be controlled by the game processing unit to display a roulette image, the roulette image displaying the game results arranged in a ring, and a plurality of bars at positions adjacent to the game results, wherein the plurality of bars correspondingly showing the substantial betting points of the adjacent game results, so that the betting amounts of the substantial betting points is displayed in proportion, and a length of each of the plurality of bars correspond to one of the plurality of range groups Pi, i=1, 2, . . . , N that the substantial betting points belong to.

Accordingly, the invention first performs grouping, so that the substantial betting points of the game results are arranged from small to large numerical values and classified to belong to the range groups Pi, and a length of each of the bars displayed by the roulette image correspondingly shows the range group Pi the substantial betting points of the game results are classified to belong to. Therefore, there will be no problem that a length of each of the bars is too short and difficult to interpret, or a length is too long to exceed a boundary of the roulette image and cannot be judged due to inappropriate scale.

### BRIEF DESCRIPTION OF THE DRAWINGS

FIG. 1 is a block diagram of a betting amount proportion display system for roulette of the invention.

FIG. 2 is a schematic diagram of a touch screen according to an embodiment of the invention.

FIG. 3 is a schematic diagram of a game status display screen according to an embodiment of the invention.

FIG. 4 is a schematic diagram of the game status display screen according to another embodiment of the invention.

FIG. 5 is a schematic diagram of the game status display screen according to another embodiment of the invention.

### DETAILED DESCRIPTION OF THE PREFERRED EMBODIMENTS

The detailed description and technical content of the invention are described below with reference to the accompanying drawings.

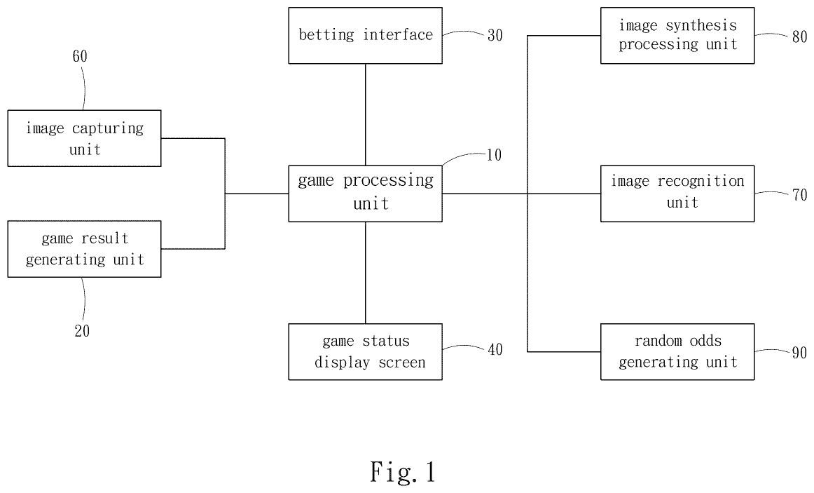

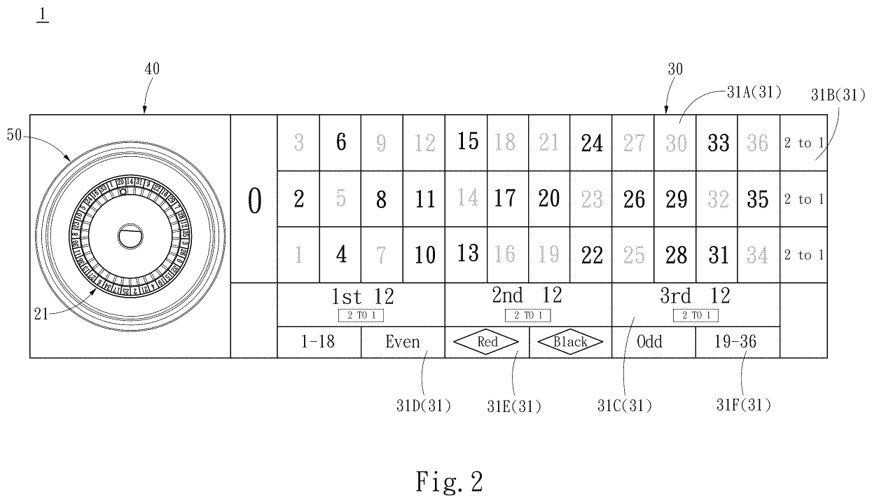

Please refer to FIG. 1 and FIG. 2, the invention provides a betting amount proportion display system for roulette, which comprises a game processing unit 10, a game result generating unit 20, a betting interface 30 and a game status display screen 40. The game processing unit 10 controls an operation of a roulette game provided for a player to play the roulette game. In one embodiment, the betting interface 30 and the game status display screen 40 are implemented on a touch screen 1.

The game result generating unit 20 is connected to the game processing unit 10. The game result generating unit 20 has a plurality of game results 21 (for example, numbers 0˜36), and after a betting time of each round of the roulette game ends, the game result generating unit 20 designates one of the game results 21 according to a preset rule and transmits the game result to the game processing unit 10. The game result generating unit 20 can be a physical roulette wheel or a random generator, wherein the random generator is a program code that can be set to randomly designate one of the numbers from 0 to 36.

The betting interface 30 is connected to the game processing unit 10. The betting interface 30 comprises a plurality of betting areas 31, and each of the plurality of betting areas 31 corresponds to at least one of the plurality of game results 21. In detail, if the game results 21 are the number 0˜36, types of the plurality of betting areas 31 include single bets 31A (“0 to 36”), column bets 31B (first column˜third column), dozen bets 31C (first dozen˜third dozen), even/odd bet 31D, red/black bet 31E (in FIG. 2, the lighter gray-scale numbers represent “red numbers”, and the darker gray-scale numbers represent “black numbers”), high/low bet 31F (“low numbers” refers to numbers “1 to 18” and “high numbers” refers to numbers “19 to 36”). For example, when the game result 21 designated by the game result generating unit 20 is “30”, the corresponding betting areas 31 are the individual number “30” of the single bet 31A, “the first column” of the column bet 31B, “the third dozen” of the dozen bet 31C, “the even number” of the even/odd bet 31D, “the red number” of the red/black bet 31E and “high numbers (19 to 36)” of the high/low bet 31F.

The betting interface 30 is provided for the player to bet on the plurality of betting areas 31 within the betting time to generate a betting datum, the betting datum records a betting amount of each of the betting areas 31, and the betting interface 30 transmits the betting datum to the game processing unit 10. After obtaining the betting datum, the game processing unit 10 calculates and obtains a substantial betting point of each of the plurality of game results 21 based on the betting amount of the plurality of betting areas 31. In detail, the betting amounts of the plurality of betting areas 31 that are not the single bets 31A, such as the column bets 31B, the dozen bets 31C, the even/odd bet 31D, the red/black bet 31E, the high/low bet 31F, are equivalently converted into the substantial betting points of the corresponding game results 21. For example, if the third dozen of the dozen bets 31C is bet and the betting amount is “1200”, then after equivalent conversion, the substantial betting points allocated to the numbers 25˜36 of the game results 21 are “100”, respectively.

In addition, the game processing unit 10 performs a numerical range classification on numerical values of the substantial betting points of the plurality of game results 21, so that the substantial betting points of the plurality of game results 21 are arranged from small to large numerical values and classified to belong to a plurality of range groups Pi, wherein “i” is one of “1, 2, . . . , N”, and “N” is greater than or equal to “3”.

In one embodiment, the range groups Pi, i=1, 2, . . . , N have an equal group interval D. As a maximum value of the substantial betting points is M, the group interval D is “M/N”, and a numerical value of the substantial betting points of the range groups Pi, i=1, 2, . . . , N is greater than “D*(i−1)”, and less than or equal to “D*i”.

For example, if the substantial betting points of the game results 21 are “100”, “100”, “80” and “60” respectively, the maximum value M=“100”. If N=“4”, then the group interval D=“100/4”=“25”. Therefore, the substantial betting point of the range group P1 is greater than “0” and less than or equal to “25”, the substantial betting point of the range group P2 is greater than “25” and less than or equal to “50”, the substantial betting point of the range group P3 are greater than “50” and less than or equal to “75”, and the substantial betting point of the range group P4 are greater than “75” and less than or equal to “100”. Therefore, the substantial betting points “100”, “80” are classified to belong to the range group P4, and the substantial betting points “60” are classified to belong to the range group P3.

In another embodiment, group intervals D of the range groups Pi, i=1, 2, . . . , N are respectively determined by predetermined settings. In more detail, the group interval D of each of the range groups Pi, i=1, 2, . . . , N is predetermined determined, so the group interval D of each of the range groups Pi, i=1, 2, . . . , N can be set according to preferences of players in different regions. For example, the group interval D of the range group PN can be made the largest. Alternatively, the group intervals D from the range group P1 to the range group PN can be gradually increased.

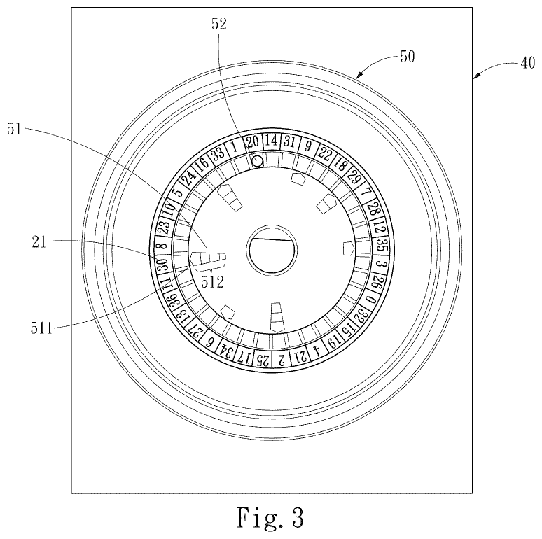

Please refer to FIG. 3 as well. The game status display screen 40 is connected to the game processing unit 10. The game processing unit 10 displays a roulette image 50 on the game status display screen 40. The roulette image 50 displays the plurality of game results 21 arranged in a ring, the roulette image 50 displays a colored ball image 52, and the colored ball image 52 is used to display which of the game results 21 is designated.

In one embodiment, the roulette image 50 displays a plurality of bars 51 at positions adjacent to the game results 21. As shown in FIG. 3, the plurality of bars 51 are located on an inner side of the plurality of game results 21. Or, in another embodiment, the plurality of bars 51 can also be located on an outer side of the plurality of game results 21. The plurality of bars 51 correspondingly show the substantial betting points of the adjacent game results 21, so that the betting amounts of the substantial betting points are displayed in proportion, and a length of each of the plurality of bars 51 correspondingly shows the range group Pi, i=1, 2, . . . , N the substantial betting points are classified to belong to. In more detail, numerical values of the substantial betting points of the plurality of game results 21 are respectively grouped into one of the range groups Pi, and the different range groups Pi are the plurality of bars 51 with different lengths. Therefore, based on a length of one of the plurality of bars 51, the range group Pi to which a numerical value of the substantial betting points is classified to belong can be quickly known.

In a preferably embodiment, as shown in FIG. 3, each of the plurality of bars 51 has an arrow symbol 511, and the arrow symbol 511 points to the corresponding game result 21. Each of the plurality of bars 51 is composed of a plurality of patterns 512, and the bar 51 has a corresponding number of the patterns 512 respectively according to the range groups Pi, i=1, 2, . . . , N. In implementation, the plurality of patterns 512 are selected from a group consisting of squares, coin symbols, and ancient Chinese coins with a square hole in a center, and can be freely configured according to preferences of players in various regions.

In one embodiment, numerical values of the substantial betting points belonging to the same range group Pi, i=1, 2, . . . , N are indicated by the corresponding bars 51 with different shades of a color, so as to facilitate the player to further grasp an amount of the substantial betting points.

In one embodiment, the plurality of bars 51 corresponding to the range groups Pi, i=1, 2, . . . , N have colors of different shades respectively, so that the player can quickly make judgments through the colors.

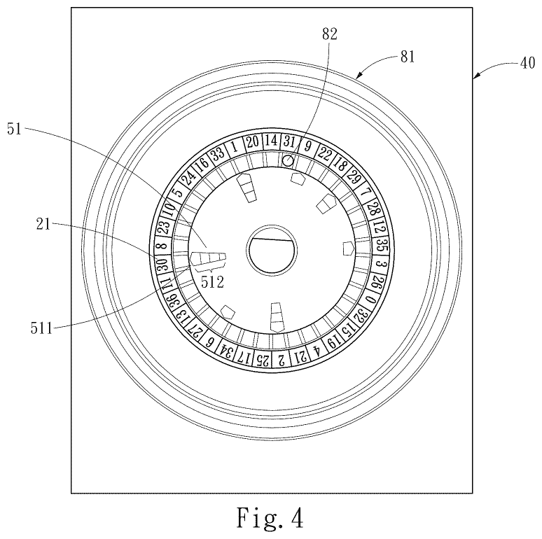

Please refer to FIG. 1 and FIG. 4 together. The invention further comprises an image capturing unit 60, an image recognition unit 70 and an image synthesis processing unit 80 connected to the game processing unit 10. In one embodiment, the game result generating unit 20 is a physical roulette wheel, and the image capturing unit 60 captures a real scene of the game result generating unit 20 to obtain a real-time image and transmits the real-time image to the game processing unit 10. The game processing unit 10 transmits the real-time image to the image recognition unit 70. The image recognition unit 70 identifies and analyzes a position of the real-time image to generate a position information and transmits the position information to the game processing unit 10. The game processing unit 10 transmits the roulette image 50 (as shown in FIG. 3), the real-time image and the position information to the image synthesis processing unit 80, and the image synthesis processing unit 80 generates a virtual-real synthesis image 81 based on the roulette image 50, the real-time image and the position information.

Then, the virtual-real synthesis image 81 is transmitted to the game processing unit 10. The game processing unit 10 transmits the virtual-real synthesis image 81 to the game status display screen 40, so that the game status display screen 40 displays the virtual-real synthesis image 81.

In implementation, during the betting time, when the betting datum changes, the bars 51 displayed by the roulette image 50 change immediately, and the image synthesis processing unit 80 updates the virtual-real synthesis image 81 in real time. In order to reduce a system load, the image synthesis processing unit 80 can generate the virtual-real synthesis image 81 only after the betting time is over.

In this way, the plurality of bars 51 in the roulette image 50 will be displayed in the virtual-real synthesis image 81, and a physical colored ball 82 of the physical roulette wheel will also be displayed in the virtual-real synthesis image 81 in real time. Therefore, the player can grasp the betting datum and the about to be generated game result 21 through the virtual-real synthesis image 81.

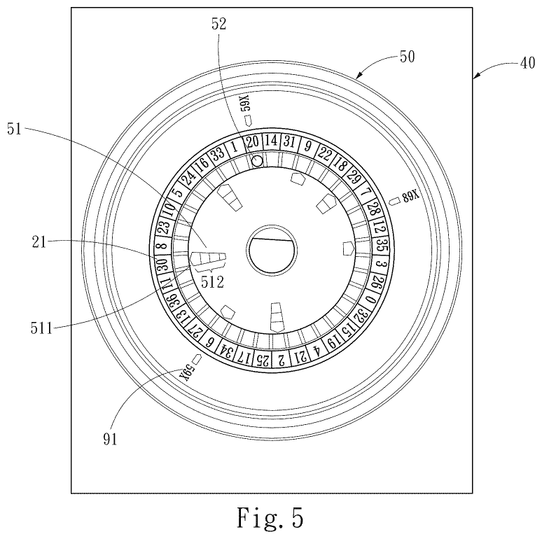

Please refer to FIG. 1, FIG. 2 and FIG. 5 together. In addition, the invention further comprises a random odds generating unit 90 connected to the game processing unit 10. The random odds generating unit 90 generates a random odds 91 according to a probability for each of the betting areas 31 after the betting time of each round of the roulette game ends, and the random odds generating unit 90 transmits the random odds 91 to the game processing unit 10. When the game processing unit 10 receives the random odds 91, the random odds 91 is displayed next to the game results 21 of the roulette image 50. In actual implementation, as shown in FIG. 5, the random odds 91 is located on an inner side of the game results 21. Or, the random odds 91 can also be located on an outer side of the game results 21.

Accordingly, compared with the prior art, the invention at least has following features.

1. The invention first performs grouping for the substantial betting points, so that the substantial betting points are arranged from small to large numerical values and classified to belong to the range groups Pi. Therefore, there will be no issues relating to the inappropriate scale due to the substantial betting points are too small or too large.

2. Since the invention enables a length of each of the bars displayed by the roulette image correspondingly showing the range groups Pi the substantial betting points of the game results are classified to belong to, the player will not have any problem that a length of each of the bars is too short and difficult to interpret, or a length is too long to exceed a boundary of the roulette image and cannot be judged.

3. The bars change in shade of color according to numerical values of the substantial betting points, which can assist the player in making judgments.

4. Real-time positions of the bars and the physical colored ball of the physical roulette wheel are simultaneously displayed in the virtual-real synthesis image, so that the player can grasp the betting datum and the about to be generated game result through the virtual-real synthesis image.

What is claimed is:

1. A betting amount proportion display system for roulette, comprising:
a game processing unit, the game processing unit configured to control an operation of a roulette game provided for a player to play the roulette game;
a game result generating unit, connected to the game processing unit, the game result generating unit comprising a plurality of game results, wherein after a betting time of each round of the roulette game ending, the game result generating unit designates one of the plurality of game results according to a preset rule and transmits the game result which is designated to the game processing unit;
a betting interface, connected to the game processing unit, the betting interface comprising a plurality of betting areas corresponding to the game results, each of the plurality of betting areas corresponding to at least one of the game results, the betting interface provided for the player to bet on the plurality of betting areas within the betting time to generate a betting datum recording a betting amount of each of the plurality of betting areas, and the betting interface transmitting the betting datum to the game processing unit, wherein after obtaining the betting datum, the game processing unit calculates and obtains substantial betting points of the plurality of game results based on the betting amount of the corresponding betting areas, and performs a numerical range classification on numerical values of the substantial betting points of the plurality of game results, so that the substantial betting points of the plurality of game results is arranged from small to large numerical values and classified to belong to a plurality of range groups Pi, wherein i is one of 1, 2, . . . , N, and N is greater than or equal to 3; and
a game status display screen, connected to the game processing unit, the game status display screen configured to be controlled by the game processing unit to display a roulette image, the roulette image displaying the game results arranged in a ring, and a plurality of bars at positions adjacent to the game results, wherein the plurality of bars correspondingly showing the substantial betting points of the adjacent game results, so that the betting amounts of the substantial betting points is displayed in proportion, and a length of each of the plurality of bars correspond to one of the plurality of range groups Pi, i=1, 2, . . . , N that the substantial betting points belong to.

2. The betting amount proportion display system for roulette as claimed in claim 1, wherein each of the plurality of bars comprises an arrow symbol, and the arrow symbol points to the corresponding game result.

3. The betting amount proportion display system for roulette as claimed in claim 2, wherein the plurality of bars are composed of a plurality of patterns respectively, and a number of the plurality of patterns of each of the plurality of bars corresponds to the range groups Pi, i=1, 2, . . . , N.

4. The betting amount proportion display system for roulette as claimed in claim 3, wherein the plurality of patterns are selected from a group consisting of squares, coin symbols, and ancient Chinese coins with a square hole in a center.

5. The betting amount proportion display system for roulette as claimed in claim 1, wherein group intervals D of the range groups Pi, i=1, 2, . . . , N are equal, a maximum value of the substantial betting points is M, the group intervals D of the range groups Pi, i=1, 2, . . . , N are M/N, a numerical value of the substantial betting points of the range groups Pi, i=1, 2, . . . , N is greater than D*(i−1), and less than or equal to D*i.

6. The betting amount proportion display system for roulette as claimed in claim 1, wherein group intervals D of the range groups Pi, i=1, 2, . . . , N are respectively determined by predetermined settings.

7. The betting amount proportion display system for roulette as claimed in claim 6, wherein the group interval D of the range group PN is the largest.

8. The betting amount proportion display system for roulette as claimed in claim 6, wherein the group intervals D from the range group P1 to the range group PN is gradually increased.

9. The betting amount proportion display system for roulette as claimed in claim 1, wherein numerical values of the substantial betting points belonging to the same range group are indicated by the corresponding bars with different shades of colors.

10. The betting amount proportion display system for roulette as claimed in claim 1, wherein one of the plurality of bar corresponding to the range group Pi, i=1, 2, . . . , N has a color with different shades.

11. The betting amount proportion display system for roulette as claimed in claim 1, wherein the plurality of bars are located on an inner side of the plurality of game results.

12. The betting amount proportion display system for roulette as claimed in claim 1, wherein the plurality of bars are located on an outer side of the plurality of game results.

13. The betting amount proportion display system for roulette as claimed in claim 1, wherein the betting amount proportion display system further comprises an image capturing unit, an image recognition unit and an image synthesis processing unit connected to the game processing unit, wherein the game result generating unit is a physical roulette wheel, the image capturing unit is configured to capture a real scene of the game result generating unit to obtain a real-time image and transmit the real-time image to the game processing unit, wherein the game processing unit transmits the real-time image to the image recognition unit, and the image recognition unit is configured to identify and analyze a position of the real-time image to generate a position information and transmitting the position information to the game processing unit, wherein the game processing unit transmits the roulette image, the real-time image and the position information to the image synthesis processing unit, and the image synthesis processing unit is configured to generate a virtual-real synthesis image based on the roulette image, the real-time image and the position information and transmitting the virtual-real synthesis image to the game processing unit, wherein the game processing unit transmits the virtual-real synthesis image to the game status display screen, and the game status display screen is configured to display the virtual-real synthesis image.

14. The betting amount proportion display system for roulette as claimed in claim 13, wherein during the betting time, when the betting datum is changed, the plurality of bars displayed by the roulette image are changed immediately, and the image synthesis processing unit updates the virtual-real synthesis image in real time.

15. The betting amount proportion display system for roulette as claimed in claim 13, wherein the image synthesis processing unit generates the virtual-real synthesis image only after the betting time is over.

16. The betting amount proportion display system for roulette as claimed in claim 13, wherein the betting amount proportion display system further comprises a random odds generating unit connected to the game processing unit, wherein the random odds generating unit is configured to generate a random odds according to a probability for each of the plurality of betting areas after the betting time of each round of the roulette game ends, and the random odds generating unit transmits the random odds to the game processing unit, wherein when the game processing unit receives the random odds, the random odds is displayed next to the plurality of game results of the roulette image.

17. The betting amount proportion display system for roulette as claimed in claim 16, wherein the random odds is located on an inner side of the plurality of game results.

18. The betting amount proportion display system for roulette as claimed in claim 16, wherein the random odds is located on an outer side of the game results.
